(19) United States
(12) Patent Application Publication
(10) Pub. No.: US 2002/0039357 A1
(43) Pub. Date: Apr. 4, 2002

(54) Addressing and routing in mobile ad hoc networks

(76) Inventors: Jaakko Lipasti, Espoo (FI); Nadarajah Asokan, Espoo (FI); Sander Van Valkenburg, Helsinki (FI)

Correspondence Address: PERMAN & GREEN, 425 POST ROAD, FAIRFIELD, CT, 06430, US

(21) Appl. No.: 09/964,908

(22) Filed: Sep. 26, 2001

(30) Foreign Application Priority Data
Sep. 29, 2000 (FI) 20002157

(51) Int. Cl. H04Q 7/24; H04L 12/28

(52) U.S. Cl. 370/338; 370/349; 370/401

(57) ABSTRACT

A method for routing packets in a mobile ad hoc network comprising a plurality of wireless mobile nodes. The mobile nodes maintain and acquire routing information on other mobile nodes and route packets to other mobile nodes on the basis of mobile node specific paths. In addition to the network layer IP addresses, mobile node specific routing addresses are composed for packets from the network layer addresses or unique device identifiers to be used as source and destination addresses of packets. Packets are routed between the mobile nodes of the mobile ad hoc network on the basis of the routing addresses.

### BACKGROUND OF THE INVENTION

The present invention relates to a method and equipment for arranging addressing and routing in mobile ad hoc networks, more precisely in mobile ad hoc networks supporting the IP (Internet Protocol).

With recent advancements in computer and wireless communications technologies, mobile wireless computing is expected to experience increasingly widespread use and applications, much of which will involve the use of the IP layer. Traditional subnetwork based routing does not always work well with wireless devices since changing subnetworks would require changing network layer, L3, addresses. Changing network addresses breaks connections in the IP networks. Within the Internet, routing support for mobile nodes is presently being formulated as mobile IP technology. The mobile IP provides a roaming node to be connected to the Internet through various means other than the well-known fixed address domain space thereof.

The idea of mobile ad hoc networks is to support a robust and efficient operation in wireless networks by incorporating a routing function into mobile nodes (MN). A mobile node generally refers to a host that changes its point of attachment from one network or subnetwork to another. A mobile node typically has a radio interface to the network. In mobile ad hoc networking, the mobile nodes themselves (which may be combined routers and hosts) form the network routing infrastructure in an ad hoc fashion. Such an ad hoc network may be established between Bluetooth devices, for example. An IETF (Internet Engineering Task Force) working group MANET (Mobile ad hoc network) defines a standard for the routing protocol of the mobile ad hoc networks, for which a number of proposals exist.

The network layer, typically the IP layer, deals with end-to-end transmission and is thus concerned with selecting the path to be followed to the destination. This process is called routing. The network layer IP addresses comprise subnet prefixes that are used to route packets in an ordinary fixed network. The packet is routed to the appropriate sub-network segment, where it is usually broadcast to the destination node using the data link layer L2 mechanisms (e.g. Ethernet). The difficulty with routing in a mobile ad hoc network is that the routers (mobile nodes) forming a part of a path from a certain source to a certain destination can move and thereby invalidate the path, even during transmission of a single packet. The routing protocol has to adapt the path when the topology changes.

Ad hoc routing does not use subnet prefixes for routing, instead each node rather maintains routing information about every destination node. This is why mobile ad hoc network addresses do not comprise a subnet portion. The ad hoc routing mechanism is thus host-based, while internet routing is subnet-based.

One possibility for arranging routing between mobile nodes is to use network layer IP addresses as in the case of protocols being developed by the MANET working group. The drawback of the network layer L3 IP-based ad hoc network routing is that it would require significant changes to the IP protocol implementation. First, if a reactive routing protocol is used, then appropriate hooks must be inserted into the IP packet forwarding code to invoke route discovery when necessary. Second, when the ad hoc network is used in a network access context, i.e. to access a fixed internetwork, the whole ad hoc network must appear as a single subnet. This requires special handling of broadcast and multicast packets, as well as the time-to-live or hop count fields in IP packets. Another possibility is to use an ad hoc network routing protocol which uses data link layer L2 addresses. In this case, when there is an outgoing IP packet, the mobile node has to first map the IP address to the data link layer address, by using something similar to ARP (Address Resolution Protocol), and then discover the route to the data link layer address. Both of these steps involve broadcasts. Broadcasts in ad hoc networks are expensive and should be minimized.

### BRIEF DESCRIPTION OF THE INVENTION

The object of the invention is to provide a new kind of address mapping and routing function for mobile ad hoc networks to alleviate the above problems. The object of the invention is achieved with a method, a mobile ad hoc network and a mobile node which are characterized by what is disclosed in the independent claims. The preferred embodiments of the invention are set forth in the dependent claims.

The invention is based on composing additional source and destination routing addresses from network layer addresses or unique device identifiers of mobile nodes of a mobile ad hoc network and routing packets inside the mobile ad hoc network on the basis of routing addresses instead of network layer or data link layer addresses. The addresses may be composed dynamically, i.e. on the basis of the sender's and recipient's network layer addresses or unique mobile node device identifiers when a packet needs to be sent. Routing is considered herein as a process, performed by the mobile node, for selecting the correct interface and next hop for a packet being forwarded.

The advantages of the invention are that the existing data link or network layer addresses may be used for routing purposes. There is no need to change the existing network (L3) or data link (L2) layers for mobile ad hoc networks, as the specific routing of the mobile ad hoc network can be performed on a specific intermediary (L2.5) routing layer. Thus, there is no need to have a separate mobile ad hoc network specific IP layer function in mobile nodes. It is possible to utilize routing addresses with any type of routing algorithm created for mobile ad hoc networks. For example, any protocol developed by the MANET working group can be used with the routing addresses.

According to a preferred embodiment of the invention, the routing addresses are composed from IP addresses. This provides the great advantage that there is no need for a protocol, such as ARP, arranging mapping from network layer addresses to data link layer addresses. This reduces the bandwidth-intensive broadcast traffic in the mobile ad hoc networks.

### BRIEF DESCRIPTION OF THE DRAWINGS

In the following, the invention will be described in further detail by means of preferred embodiments and with reference to the accompanying drawings, in which

FIG. 1 is a block diagram showing a mobile ad hoc network connected to an access point;

FIG. 2 illustrates a packet comprising the network layer L3 and routing layer L2.5 headers;

FIG. 3 illustrates a 64 bit L2.5 routing address composed from a Bluetooth BD_ADDR address;

FIG. 4 illustrates a 64 bit L2.5 routing address composed from an IPv4 address;

FIG. 5 illustrates a 64 bit L2.5 routing address composed from an IPv6 address;

FIG. 6 illustrates a 48 bit L2.5 routing address composed from an IPv4 address;

FIG. 7 illustrates a 48 bit L2.5 routing address composed from an IPv6 address; (our translator changed earlier the pronouns)

FIG. 8 is a flow diagram illustrating the basic function of a mobile node MN sending packets according to a preferred embodiment of the invention;

FIG. 9 is a flow diagram illustrating the routing function of a mobile node MN according to a preferred embodiment of the invention; and

FIG. 10 illustrates the protocol layers of a mobile node according to a preferred embodiment of the invention.

### DETAILED DESCRIPTION OF THE INVENTION

In the following description the telecommunications network is assumed to be a Bluetooth network, yet without limiting the invention to such a particular network. The invention can be used in any kind of mobile ad hoc network such as a network according to the IEEE 802.11 WLAN (Wireless Local Area Network), HomeRF or BRAN (Broadband Radio Access Networks) specifications (HIPERLAN1,2, HIPERACCESS).

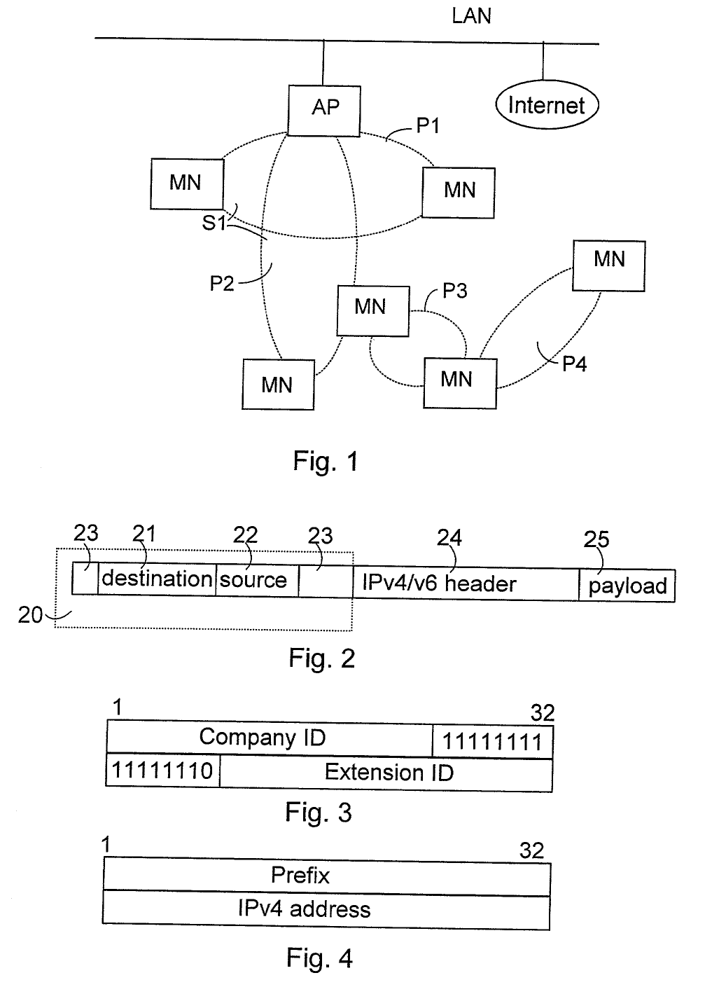

Referring to FIG. 1, the function of a Bluetooth network in a network access context will be described. Mobile nodes MN are wireless Bluetooth devices, and another kind of Bluetooth device, an access point AP, provides access for Bluetooth mobile nodes to the local area network LAN and to other networks, such as the Internet. Two or more Bluetooth devices MN, AP may establish, within the coverage area of the Bluetooth transmitters, an ad hoc network which is called a pico network. Examples of such pico networks are P1, P2, P3 and P4. It should be noted that the AP is not as such a part of the ad hoc network but may, however, forward packets to and from an ad hoc network and thus participate in ad hoc network routing. The device initiating the connection becomes the master device. All the other Bluetooth devices are slaves to the master device of the pico network and their clocks are synchronised to the master device's clock. It is possible to perform a masterslave switch, thus effectively reversing the roles. All devices in the original piconet will have to join the new piconet defined by the new master.

An internationally available frequency band around 2.45 GHz is used for the Bluetooth devices. Data transfer is arranged by frequency hopping based on spread spectrum technology. The used frequency band is divided into 1 MHz hopping frequency slots where the slots are alternated between devices belonging to the pico network. A Bluetooth device comprises a Bluetooth module which is a microcircuit comprising a radio transceiver. A Bluetooth device may be integrated for example in a mobile phone, a wireless head set microphone combination or any computer device such as a laptop computer or a printer.

A Bluetooth device may belong to several pico networks at the same time. Two or more pico networks may form a scatter network S1, scatternet. Therefore it is possible to interconnect the Bluetooth devices belonging to different pico networks. Each Bluetooth device is defined with a specific 48-bits long identifier called a BD_ADDR. The BD_ADDR identifier is mapped to an AM_ADDR (Active Member Address) which is used for sending packets between the Bluetooth devices inside the pico networks. When transferring packets to/from other networks, the access point AP comprises a gateway function for performing the required protocol conversion.

According to a preferred embodiment of the invention, special routing addresses, also called the L2.5 addresses, are composed from network layer addresses or from unique mobile node device identifiers (typically data link layer Medium Access Control MAC addresses) and used for routing packets inside a mobile ad hoc network. This means that a new protocol layer, L2.5, is added between the data link layer and the network layer, handling routing inside the mobile ad hoc network. The specific L2.5 routing addresses are especially useful in data transmission in the Bluetooth scatternets, i.e. between pico networks. FIG. 2 illustrates a packet according to an embodiment of the invention, the packet comprising a L2.5 header 20 having an L2.5 source 22 and an L2.5 destination 21 routing addresses. There are also other fields 23 in the L2.5 header such as routing information extensions, type information and/or time-to-live/hop count information. The routing information extensions depend on the selected mobile ad hoc network routing protocol. For example, according to a routing protocol (such as a Dynamic Source Routing DSR), the entire path to the destination is added to the routing extension. The IP header 24 is in accordance with the IP version 4 or version 6, and comprises the network layer (L3) source and destination addresses. The payload 25 comprises a UDP (User Datagram Protocol) or TCP (Transmission Control Protocol) headers and application data.

Specific routing addresses besides IP addresses can be used for addressing and routing in mobile ad hoc networks, for example in the Bluetooth scatternets. This is especially useful when sending a packet to an IP address since the layer 2.5 destination routing address can be directly deduced from the IP destination address, i.e. no MAC address inquiry using ARP requests is necessary. Especially suitable are 64-bit addresses since the 64-bit layer 2.5 addresses can be mapped to the IPv4, IPv6 and 48-bit Bluetooth BD_ADDR addresses. In the following different address mappings are illustrated.

Address Mappings

The primary mappings are from the network layer IPv4 and IPv6 addresses to L2.5 64-bit addresses. This scheme allows the foregoing ARP (IPv4) or neighbour discovery protocols (IPv6). However, especially in the IP address configuration stage it is useful to generate temporary L2.5 addresses also from the existing unique mobile node device identifiers (e.g. BD_ADDR in Bluetooth devices or other IEEE 802 hardware identifiers guaranteed to be unique).

Mapping of Bluetooth BD_ADDR to 64-bit L2.5 Routing Address:

As illustrated in FIG. 3, the data link layer 48-bit Bluetooth BD_ADDR (i.e., IEEE 802 address) can be mapped to the 64-bit L2.5 routing address by adding 0×FFFE in bits 25-40. Together the Company ID and Extension ID form a 48-bit IEEE 802 address. If the IEEE (Institute of Electrical and Electronics Engineers) decides to use 64-bit addresses instead of the current IEEE 802 48-bit addresses, then the mapping is direct e.g. in the Bluetooth devices, i.e. the L2.5 64-bit addresses will be exactly identical to the IEEE 64-bit addresses.

Mapping of IPv4 Address to 64-bit L2.5 Routing Address:

As illustrated in FIG. 4, the IPv4 addresses can be prefixed with zeroes or a special reserved prefix to make 64-bit L2.5 addresses.

Mapping of IPv6 Address to 64-bit L2.5 Routing Address:

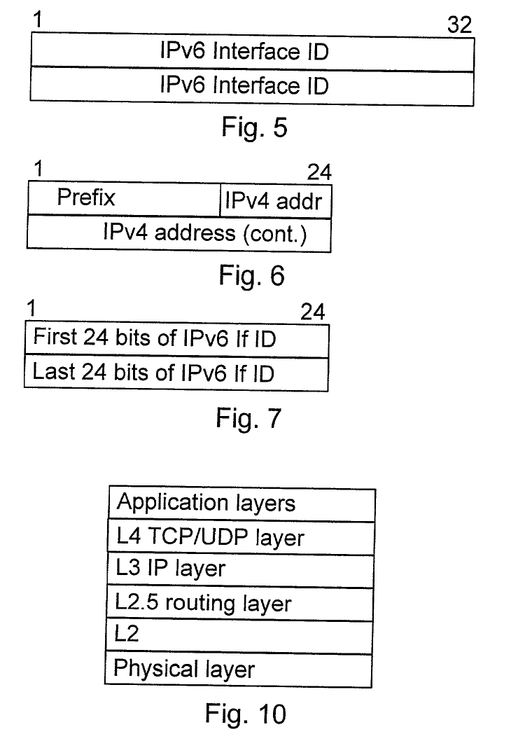

As illustrated in FIG. 5, mapping of the IPv6 address can be done by taking the address Interface Id as the L2.5 address. To guarantee uniqueness with BD_ADDR mapping, the special prefix used in IPv4 mapping and 0×FFFE (binary 1111111111111110) in bits 25-40 should be avoided in the IPv6 addresses for the mobile ad hoc network devices. If the Bluetooth devices use the new 64-bit IEEE addresses, then, to guarantee uniqueness with them, the IPv6 addresses used have to use a specific company id (see FIG. 3) which is reserved for dynamic addresses.

Mapping of Bluetooth BD_ADDR to 48-bit L2.5 Routing Address:

One alternative for the 64-bit addresses is to use 48-bit L2.5 routing addresses. The existing 48-bit BD_ADDR can be directly used as the 48-bit L2.5 address.

Mapping of IPv4 Address to 48-bit L2.5 Routing Address:

As illustrated in FIG. 6, the IPv4 addresses can be added with zeroes or a special reserved prefix to make 48-bit L2.5 addresses.

Mapping of IPv6 Address to 48-bit L2.5 Routing Address:

As illustrated in FIG. 7, 48 bits of the IPv6 Interface Id can be directly mapped into the 48-bit L2.5 address. Since the first 24 and the last 24 bits of the Interface Id are used, 0×FFFE can be avoided in the middle. This scheme obviously puts restrictions on the choice of the IPv6 addresses for ad hoc devices. To guarantee uniqueness with the L2.5 addresses, the first 16 bits of the Interface Id need to be fixed to some bit pattern (e.g. 0×0000 or some special reserved prefix).

Bluetooth mobile node specific addresses are guaranteed to be globally unique. This is achieved by managing the Bluetooth address allocation according to the IEEE 802 standard. A separate prefix is reserved for each Bluetooth device manufacturer and they are responsible for assigning different suffixes for their devices. The “special reserved prefix” referred to above should be a prefix assigned by the central allocation authority for the purpose of mapping IP addresses to L2.5 routing addresses as described earlier. This prefix is therefore guaranteed not to conflict with a prefix assigned to a Bluetooth device manufacturer.

In case of network level multicast packets, the network level multicast addresses may be mapped to the routing layer L2.5 64-bit broadcast address. A more sophisticated way with more efficient use of bandwidth is to reserve 1 bit from the L2.5 routing addresses for specifying a multicast address (vs. unicast address). This reduces L2.5 routing address size by 1 bit and thus puts further restrictions on MN usable IPV6 addresses.

Transmission of Packets Using L2.5 Routing Addresses

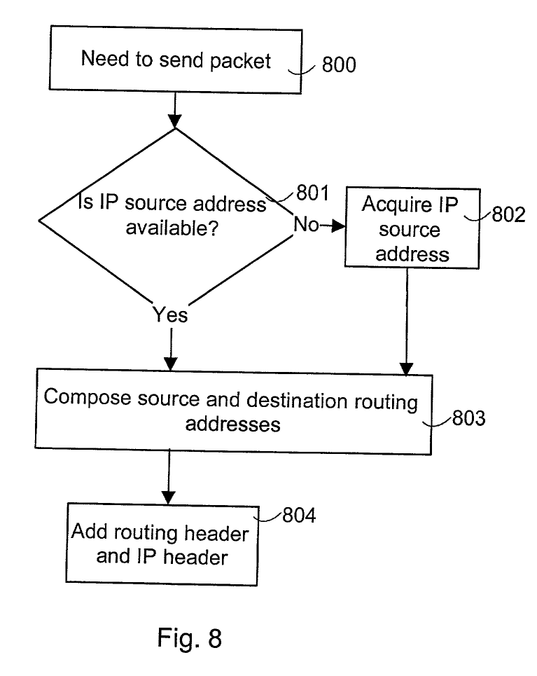

FIG. 8 illustrates the basic function of a mobile node MN sending packets according to a preferred embodiment of the invention. As a need to send a packet comprising a destination IP address arises 800, it is checked 801 if a source IP address is available. If there is no fixed IP address for the MN, the MN acquires 802 one dynamically. The IP address may be acquired from a DHCP server (IPv4 or IPv6) or a stateless address autoconfiguration procedure is performed (in the case of IPv6).

The following shows an example of how IPv4 address acquisition can be done using the DHCP servers and the 64-bit layer 2.5 routing addresses. A request is sent to the DHCP server:

Mobile Node MN→DHCP server: (DHCP Discovery-message)

L3 Destination: local subnet broadcast (all 1s)

L3 Source: unspecified (all 0s)

L2.5 Destination (21): 64-bit broadcast address

L2.5 Source (22): 64-bit L2.5 address derived from 48-bit BD_ADDR

The L2.5 64-bit broadcast address can be defined as e.g. all 1s. Alternatively the mobile node can set the broadcast flag in the DHCP Discover/Request message, in which case there is no need for the L2.5 source address (the DHCP reply would be broadcast back to the mobile node).

DHCP server responds with an IP address to the MN:

DHCP server→Mobile Node MN: (DHCP Offer-message)

L3 Destination: unspecified address

L3 Source: address of DHCP server

L2.5 Destination (21): MN address obtained from discovery packet

L2.5 Source (22): DHCP server address

Payload (25): new IPv4 address for the mobile node

The proposed L2.5 routing addresses can be used for acquiring the network layer L3 IPv6 addresses by the stateless address autoconfiguration procedure. The MN first generates, or is statically configured with, an IPv6 address and then performs duplicate address detection on the Interface ID (i.e. the last 64 bits of the IPv6 address). The duplicate address detection is performed in order to assure that the address is unique. The detection may be performed in the following manner using the 64-bit L2.5 routing addresses:

The MN multicasts neighbour solicitation message:

L3 Destination: solicited node multicast address

L3 Source: unspecified address

L2.5 Destination (21): 64-bit broadcast address

L2.5 Source (22): 64-bit L2.5 address derived from BD_ADDR

or unspecified address (could be defined e.g. as zeros)

If a network layer L3 address is already in use, the duplicate host responds with a neighbour advertisement message:

L3 Destination: multicast-all-nodes address

L3 Source: host address

L2.5 Destination (21): 64-bit broadcast address

L2.5 Source (22): host 64-bit L2.5 address

If a duplicate address is found, the mobile node can generate another address and re-run the duplicate address detection. The IPv6 address acquisition does not really need any special L2.5 addresses, since the response is sent back as a broadcast message. It could be possible, however, to use the BD_ADDR-derived L2.5 address as in the IPv4 case.

The IPv6 DHCP requests work as shown in the IPv4 case, requiring L2.5 addresses for the reply message, unless the broadcast is used.

Referring again to FIG. 8, as the mobile node has acquired an IP address, either dynamically or using a fixed one, it composes 803 the L2.5 source and destination routing addresses for the packet to be sent. The L2.5 routing destination address (21) is constructed from the packet's destination IP address and the L2.5 source address from the acquired IP address. The packet is prepended 804 with a network layer IP header 24 and with a L2.5 header 20 and may be sent:

Mobile node→IP address x

L3 Destination: IP address x

L3 Source: newly acquired IPv4 address

L2.5 Destination (21): L2.5 address derived from L3 destination

address

L2.5 Source (22): 64-bit L2.5 address derived from the newly acquired IPv4 address

As in this example, it is preferred that the L2.5 routing addresses are always derived from IP addresses if possible. The original BD_ADDR-derived L2.5 address used for IP address acquisition quickly times out from the routing information caches, since it will not be used subsequently. When L2.5 routing addresses are used, no ARP is required in packet transmission.

In some ad hoc networking scenarios (e.g. involving light-weight game devices) it may be desirable to omit L3 protocols entirely. In those cases, using routing (ie. L2.5) addresses mapped from L2 addresses on a permanent basis may be desirable.

Routing of Packets Using L2.5 Routing Addresses

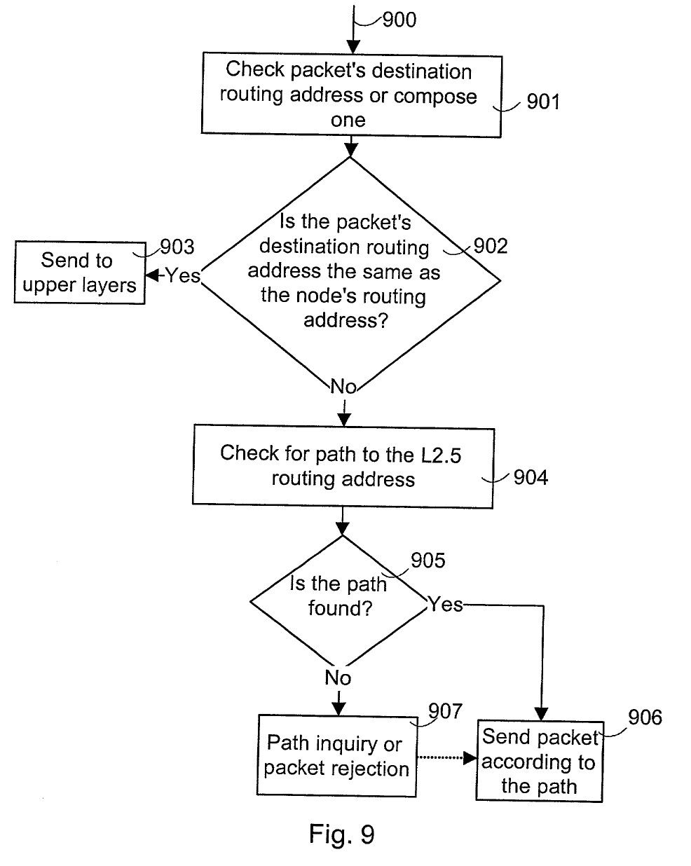

One example for arranging the routing function of a mobile node MN is illustrated in FIG. 9. As already mentioned, routing in mobile ad hoc networks differs from routing in ordinary fixed networks. In ad hoc networks the routing address (in this invention the L2.5 routing address) unambiguously determines the mobile node MN in question. Consequently there is a separate path for each mobile node MN. Intermediary nodes have to determine the path on the basis of the L2.5 routing address either based on stored paths (routing table) or on dynamically obtained paths.

A packet may arrive 900 to the routing function either from another mobile node or it may originate from the mobile node itself (after phase 804 in FIG. 8). The routing function checks 901 the L2.5 routing destination address (21) of the packet. If the packet does not comprise the L2.5 routing destination address (21), one is composed 901 from the network layer IP destination address as explained above. It is checked 902 if the L2.5 routing destination address (21) is the same as the mobile node's specific L2.5 routing address. If so, the packet is sent 903 to the upper layers. If not, the path to the discovered L2.5 routing destination address (21) is checked 904.

If the path is discovered, on the basis of the check 905, the packet may be sent 906 to the next mobile node MN according to the discovered path. If the path is not discovered, the routing function may broadcast 907 a path inquiry on the basis of the L2.5 routing destination address (21) and send 906 the packet according to the responded path, if any. Otherwise the packet will be discarded 907. The path discovery may be done in many ways depending on the selected routing algorithm. It is important to note that the transferred packets may not comprise non-user data and are not necessarily IP packets. This is the case for routing information exchange packets, i.e. packets comprise the L2.5 routing header 20 and routing information as a payload 25 (no IP header 24).

The routing protocol used determines the mechanism for path establishment based on the composed L2.5 routing addresses. In proactive routing protocols, a routing table is maintained in the memory of mobile nodes in which information about paths to different mobile nodes is stored. The mobile nodes periodically exchange routing information using specific routing information exchange packets. In this case the path is checked 904 from the routing table and the packet is sent 906 or the packet is discarded 907. In reactive routing protocols, also known as on-demand protocols, the path is dynamically inquired when a packet needs to be sent. However, the path may be stored in the memory for some time and an inquiry (907) is not always needed. Further, some routing protocols provide source routing, i.e. the source node may inquire the path and add routing information extensions (23) to packets describing the path to the destination L2.5 address. Intermediary mobile nodes then check the path 904 from the packet L2.5 routing header instead of the routing table or the dynamic query.

Several routing protocols are being developed for mobile ad hoc networks:

Ad Hoc On-Demand Distance Vector (AODV)

On-Demand Multicast Routing Protocol (ODMRP)

Optimized Link State Routing Protocol (OLSR)

Differential Destination Multicast (DDM) routing protocol

Multicast Ad hoc On-Demand Distance Vector (MAODV) routing protocol

Topology Broadcast based on Reverse-Path Forwarding (TBRPF)

Dynamic Source Routing (DSR)

Temporally-Ordered Routing Algorithm (TORA)

Zone Routing Protocol for Ad Hoc Networks (ZRP)

Source-Tree Adaptive Routing (STAR).

The invention may be used with any routing protocol designed for mobile ad hoc networks. As an example, the basic principles of the AODV protocol are presented: The AODV is a proactive routing protocol that uses hop-by-hop routing. When a source needs a route to a destination and the path is not known or valid anymore, a Route Request (RREQ) is broadcast. The route can be determined when the RREQ reaches either the destination itself, or an intermediate node with a fresh enough route to the destination. Each node that knows the path replies to the source with a Route Reply (RREP) comprising the path. Destination sequence numbers are used for the nodes to prevent packets from looping. For each route, only the destination address and the next hop address are kept in the routing table in order to avoid large routing tables. Each entry in the routing table is given a lifetime to indicate how long a route is valid.

The above mentioned access point AP may also be considered as a mobile node and perform the functions illustrated in FIGS. 8 and 9. However, if the AP functions as a bridge, it needs to remove the mobile ad hoc network specific L2.5 routing header for packets transferred to a wired network LAN and add a data link layer specific header according to the LAN and vice versa for packets to the mobile ad hoc network. If the AP functions as a router, the L2.5 header is removed and the network layer L3 routing is applied. Obviously, the lower layer headers are changed according to the outgoing interface.

The use of 64-bit L2.5 routing addresses has many advantages: ARP is not needed if direct mapping can be guaranteed. The addressing operates with any ad hoc routing scheme. The same address can be used for routing instead of the IPv6, IPv4 and BD_ADDR addresses. Both stateless and stateful (e.g. DHCP) address autoconfiguration can be efficiently executed. If the 64-bit data link layer L2 addresses are taken into use, they also operate well with the described addressing scheme. It is also possible to use the 48-bit L2.5 addresses in a similar fashion. The only drawback is that the length of the IPv6 Interface Id is effectively limited to 48 bits.

FIG. 10 illustrates the protocol layers of a mobile node according to a preferred embodiment of the invention. A physical layer enables wireless data transmission between the mobile nodes such as the Bluetooth devices (MN, AP). In the Bluetooth, the data link layer L2 comprises the Bluetooth logical link control and adaptation protocol L2CAP that adapts upper layer protocols over the baseband. Also the link manager protocol LMP is part of the Bluetooth the data link L2 layer and responsible for link set-up between the Bluetooth devices. According to a preferred embodiment of the invention, the L2.5 routing layer is added between the L2 and the L3, IP layer. Above the IP layer there is an L4 transmission layer using TCP or UDP and application layers, for instance WAP (Wireless Application Protocol) layers.

The present invention can be implemented in existing mobile nodes of mobile ad hoc networks. They all include processors and memory, with which the inventive functionality described above may be implemented. The functions relevant to the invention, such as the control means for performing address mapping, path discovery and packet transmission control, may be implemented as processor executable software. It is also possible to use hardware solutions such as ASIC (Application Specific Integrated Circuit) or separate logic.

The accompanying drawings and the description pertaining to them are only intended to illustrate the present invention. Different variations and modifications to the invention will be apparent to those skilled in the art, without departing from the scope and spirit of the invention defined in the appended claims.

1. A method for routing packets in a mobile ad hoc network comprising a plurality of wireless mobile nodes, wherein the mobile nodes maintain routing information on other mobile nodes, the method comprising the steps of:
composing, in addition to network layer addresses, mobile node specific routing addresses from network layer addresses or unique mobile node device identifiers to be used as source and destination addresses of packets, and
routing packets between the mobile nodes in the mobile ad hoc network on the basis of the routing addresses.

2. A method according to claim 1, wherein
the destination routing address of a packet to be routed is checked,
the destination routing address from the IP address of the packet is composed if no destination routing address exists,
the path to the destination routing address is checked, and
the packet is sent to the next hop of the discovered path.

3. A method according to claim 2, further comprising the step of:
maintaining a routing table for the paths to the mobile nodes, and checking the path from the routing table.

4. A method according to claim 2 or 3, wherein
the path to the destination routing address is checked by broadcasting an inquiry to other mobile nodes if there is no routing table or no valid path available in the routing table.

5. A method according to claim 4, further comprising the step of:
adding a routing extension to the packet describing the path in the source mobile node sending the packet, and
checking, in the intermediary mobile nodes, the path from routing extension of the packet.

6. A method according to claim 1, wherein
the destination and source routing addresses are composed from the network layer destination and source IP addresses.

7. A method according to claim 6, wherein
the 64-bit routing addresses are composed by prepending zero bits or a special prefix to the IPv4 addresses, or
the 64-bit routing addresses are composed by using only the interface ID portion of the IPv6 addresses.

8. A method according to claim 1, wherein
the routing addresses are composed from unique mobile node device identifiers such as the IEEE 802 addresses,
the routing addresses composed from the unique mobile node device identifiers are used when acquiring an IP address for a mobile node, and
the source routing address is composed for packets originating from the mobile node on the basis of the acquired IP address.

9. A method according to claim 1, wherein
the routing is performed on the basis of one of the following routing protocols:
Ad Hoc On-Demand Distance Vector (AODV)
On-Demand Multicast Routing Protocol (ODMRP)
Optimized Link State Routing Protocol (OLSR)
Differential Destination Multicast (DDM) routing protocol
Multicast Ad hoc On-Demand Distance Vector (MAODV) routing protocol
Topology Broadcast based on Reverse-Path Forwarding (TBRPF)
Dynamic Source Routing (DSR)
Temporally-Ordered Routing Algorithm (TORA)
Zone Routing Protocol for Ad Hoc Networks (ZRP)
Source-Tree Adaptive Routing (STAR).

10. A mobile ad hoc network comprising a plurality of wireless mobile nodes, wherein
the mobile nodes are configured to maintain routing information on other mobile nodes,
the mobile nodes are configured to compose, in addition to network layer addresses, mobile node specific routing addresses from the network layer addresses or unique mobile node device identifiers to be used as source and destination addresses of packets, and
the mobile nodes are configured to route packets inside the mobile ad hoc network on the basis of the routing addresses.

11. A mobile ad hoc network according to claim 10, wherein
the ad hoc network is a short range radio frequency network and the mobile nodes support the Bluetooth specification.

12. A mobile node of a mobile ad hoc network, wherein
the mobile node is configured to maintain routing information on other mobile nodes,
the mobile node is configuredcompose, in addition to network layer addresses, mobile node specific routing addresses from the network layer addresses or unique mobile node device identifiers to be used as source and destination addresses of packets, and
the mobile node is configured to route packets inside the mobile ad hoc network on the basis of the routing addresses.

13. A mobile node according to claim 12, wherein the mobile node is configured to:
check the destination routing address of a packet to be routed,
compose the destination routing address from the IP address if there is no destination routing address,
check the path to the destination routing address, and
send the packet to the next hop of the discovered path.
